(19) United States
(12) Patent Application Publication
(10) Pub. No.: US 2024/0354051 A1
(43) Pub. Date: Oct. 24, 2024

(54) Multi-User Media Playback System

(71) Applicant: SONOS, INC., Santa Barbara, CA (US)

(72) Inventors: Ryan MOAK, Boston, MA (US); Jillian GARBER, Issaquah, WA (US); Nikit WAGHELA, Jersey City, NJ (US); Gregory P. RAMSPERGER, Portland, OR (US)

(21) Appl. No.: 18/635,595

(22) Filed: Apr. 15, 2024

Related U.S. Application Data
(60) Provisional application No. 63/459,882, filed on Apr. 17, 2023.
(60) Provisional application No. 63/459,887, filed on Apr. 17, 2023.
(60) Provisional application No. 63/459,897, filed on Apr. 17, 2023.

(51) Int. Cl. G06F 3/16

(52) U.S. Cl. CPC G06F 3/165

(57) ABSTRACT

Multi-user media playback systems are disclosed. In an example, a main account associated with a media playback system can invite additional accounts to access resources of the media playback system. An explicit association between the additional accounts and one or more of: the main account or the resources of the media playback system can be generated and stored based on the invite. When an access request to access a particular resource of the media playback system is received from a particular additional account, it can be determined whether the additional account has access to the particular resource based on an explicit association between the particular additional account and the particular resource and/or based on one or more implicit associations. In some examples, the one or more implicit associations can be derived from a topology of the media playback system.

### CROSS-REFERENCE TO RELATED APPLICATIONS

This application claims priority to U.S. Provisional Application No. 63/459,882, filed Apr. 17, 2023 and titled “Management of Media Playback System Splits and Location Designation for Partitions of a Media Playback System”, U.S. Provisional Application No. 63/459,887, filed Apr. 17, 2023 and titled “Multi-User Media Playback System”, and to U.S. Provisional Application No. 63/459,897, filed Apr. 17, 2023 and titled “Media Playback System Switcher”, the contents of each of which are incorporated by reference in their entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIG. 2 includes a diagram illustrating an example representation of a media playback system topology, in accordance with embodiments described herein.

FIG. 3 includes a flowchart for a set of example methods that can be performed by a computing system, in accordance with embodiments described herein.

FIG. 4A includes a diagram of example first associations, in accordance with embodiments described herein.

FIG. 4B includes a diagram of example second associations, in accordance with embodiments described herein.

FIG. 4C includes a diagram of example additional second associations, in accordance with embodiments described herein.

FIG. 5A includes a set of flowcharts for a set of example methods of inviting additional accounts to access a media playback system, in accordance with embodiments described herein.

FIG. 5B includes a set of flowcharts for a set of example methods of adding additional accounts to access a media playback system, in accordance with embodiments described herein.

FIG. 6 includes a set of flowcharts for a set of example methods of requesting and sending data regarding additional accounts associated with a media playback system, in accordance with embodiments described herein.

FIG. 7 includes an example graphical user interface associated with a main account, in accordance with embodiments described herein.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Media playback systems comprising a large number of distributed playback devices can be difficult to manage. One feature that could facilitate operation might be the ability to manage different parts of the media playback system independently and remotely. Additionally, it might be beneficial to allow multiple different users to manage and/or at least access certain resources of the media playback system to provide for a more distributed management/access scheme.

One example scenario in which these features might be useful could include a media playback system deployed for a business or company having multiple locations and/or multiple employees. In this scenario, it could be beneficial to provide centralized management capabilities so that at least one user (e.g., a system owner, an installer, an administrator, etc.) could manage all and/or any aspects for the entire media playback system. However, it could also be beneficial to allow for some kind of distributed management and/or access so that other users (e.g., administrators, managers, employees, etc.) are allowed to manage/access at least some aspects of the media playback system.

In instances in which the media playback system is split into multiple partitions/locations, it could be beneficial to allow users to manage and/or access at least certain aspects for certain locations of the media playback system. For example, a media playback system could be distributed across multiple branches of a business. Different media playback system administrators could be designated for each branch so that the respective administrator can access/manage at least some aspects of the media playback system resources for the branch (e.g., any playback devices in the branch). As another example, employees at the branch could be allowed to access/manage at least certain aspects for the media playback system resources at the branch.

Providing a multi-user system, however, can be challenging in multiple ways. There are safety concerns associated with the idea of allowing multiple users to access the same system in that it may be difficult to control access, track down, trace back, and/or control user actions. Having multiple users accessing a media playback system can increase the risks of errors when managing the system. For example, contradictory or simultaneous actions taken by different users could cause misconfigurations and/or cause the media playback system to take an inappropriate action (e.g., start/stop playback by a particular playback device).

This issue becomes more important considering media playback systems with a large number of distributed resources in that users may end up accessing the wrong resource, for example accessing a playback device in a location different than the location where the user is at. Specially for commercial environments, there are also concerns around the number of users that could potentially gain (either authorized or unauthorized) access to the media playback system (e.g., clients), the kind of media that should be played back (e.g., licensed content, non-explicit content, etc.), the hours in which media should/should not be played back, the volume at which media should be played back, etc.

Some solutions related to the challenges above involve sharing access credentials for a media playback system account between users, so that only users with access to the credentials can access the system. These solutions may present safety and privacy risks intrinsic to a scheme in which it may be difficult to control who has information about the credentials and who may have access to the system. Furthermore, by sharing credentials, different users can access instances of a same account and might therefore be subject to (or allowed) the same level of access/management. Individual and/or more granular management may be difficult to achieve.

Other solutions involve sharing access with users based on roles such that users have different privileges within a system based on their role. Such solutions are generally directed to media playback systems deployed on a given domain (e.g., a network such as a Local Area Network-LAN) in which settings and access configuration can be easily replicated between devices. In those cases, access can be controlled for any playback devices in the given domain. Furthermore, most cases require that the device being used to control de system is also in the same domain in order to be able to access the media playback system.

Example techniques for sharing access to a media playback system with multiple users have been described in U.S. Pat. No. 10,498,833, filed Jul. 14, 2014, entitled “Managing Application Access of a Media Playback System”, U.S. Pat. No. 9,876,780, filed Jan. 27, 2015, entitled “Sharing Access to a Media Service”, U.S. Pat. No. 11,184,666, filed Apr. 1, 2019, entitled “Access Control Techniques for Media Playback System”, and U.S. Pat. Pub. No. 20220360585, filed May 9, 2022, entitled “Authorization Management in a Media Playback System”, all of which are incorporated by reference herein in their entirety.

Some of the solutions above offer ways to grant access to specific resources in the system, such as playback devices or group(s) of playback devices in a media playback system. In most cases, access is granted to the ultimate resource that users may want to access and/or are allowed to access (e.g., playback devices and/or groups of playback devices). These solutions, however, may not be the most efficient for commercial or other environments with larger media playback systems which may have a more dynamic topology and/or more dynamic set of users accessing the media playback system. Media playback systems for these types of environments may be more prone to changes to adapt and/or scale to more/less employees, more/less locations, more/less playback devices, etc. Furthermore, these types of systems may often benefit from more flexibility because resources (e.g., playback devices) and users (e.g., employees, clients) may be added, moved, and/or removed from the system more frequently. There is a need for a multi-user system suitable for such scalable and distributed media playback systems.

Embodiments described herein relate to multi-user media playback systems configured to solve for some of the challenges discussed above. In accordance with some examples described in this disclosure, a media playback system can be registered with a main account associated with (e.g., registered with, belonging to, etc.) a user or any other type of entity such as a business, a company, etc. The media playback system and/or corresponding main account can be in turn associated with additional accounts that are granted access to certain resources within the media playback system. Resources of a media playback system can include playback devices, groups of playback devices, partitions of the media playback system (and/or locations), groups of partitions or locations, etc.

In some instances, additional accounts are explicitly associated with, and/or explicitly granted access to, resources in the media playback system. The system can be configured to control access to a particular resource based on any access/permissions explicitly granted (“explicit grants”) to the account attempting to access the particular resource. The explicit grants can be established by the main account. For example, the main account can grant explicit access to a particular resource by identifying the particular resource via an invitation/onboarding process for the additional accounts or at any other time.

In some instances, additional accounts are implicitly associated with, and/or implicitly granted access to, resources in the media playback system. The system can be configured to control access to a particular resource based on any access/permissions implicitly granted (“implicit grants”) to the account attempting to access the particular resource. The implicit grants are not necessarily directly established by the main account and can instead be determined based on (e.g., derived from) any explicit grants and/or additional data available to the system. For example, the additional accounts can have implicit access to any resource associated with the particular resource they have been granted explicit access to, even if a direct association does not exist between the additional account and the ultimate resource it is trying to access (to which it has implicit access).

Implicit grants can be determined based on any data available to the system. In some instances, implicit grants are determined based on a topology of the media playback system. The topology of the media playback system can comprise any number of nodes corresponding to resources and/or group of resources in the media playback system. In this way, as resources are added, removed or changed within the system, the topology can be updated accordingly and any changes can be reflected in the implicit grants.

The system topology (or any other data used to determine implicit grants) can change dynamically based on a number of factors. The topology can change, for example, due to changes in the resources distribution within the system, when one or more partitions, locations and/or playback devices are added/removed in the media playback system, etc. In accordance with some embodiments described in this disclosure, the implicit grants could change accordingly even when the explicit grant originally established for a particular additional account remains the same.

The multi-user systems described in this disclosure could offer flexibility and scalability to a system with any number of playback devices and/or users. For example, a commercial establishment with a set of playback devices in a given partition/location could have a system administrator for their media playback system. The owner of the commercial establishment could grant the system administrator explicit access to the playback devices in the system. As the establishment grows (e.g., to a second floor) and more playback devices are installed, the system owner may need to grant access to the new playback devices to the administrator so that the administrator is authorized to access them. On the other hand, in accordance with some of the embodiments described herein, the system administrator could be granted explicit access to the location rather than to each playback device in the location. In this way, when playback devices are added to the location, the system administrator can already have implicit access to such devices. Similarly, if the location is eventually split into two or more locations (e.g., upstairs and downstairs), the system administrator could have implicit access to each of the new locations based on their explicit access to the original location.

As another example, a company with multiple locations could have regional managers for groups of locations within the same region. The company could grant the regional managers explicit access to each location in the region. However, as the system grows and expands to new locations in the region, the regional managers would need to be granted explicit access to the new locations in order to access them. On the other hand, in accordance with some of the embodiments described herein, the regional managers could be granted explicit access to the region rather than to the specific locations within the region. When locations are added to the region and the system topology changes, the system administrator can continue to have explicit access to the region and therefore implicit access to any location in the region, including the new location that did not exist when the regional manager was granted explicit access to the system, based on both the explicit grant and the system's topology. Furthermore, and also based on explicit grants and the system's topology, each regional manager may be prevented from accessing other locations in other regions. In this way, if resources (e.g., playback devices) are moved from one region to another, the regional managers could gain/lose access to such resources based on the explicit grant to the region and the system's topology indicating where the resource belongs to in the system, without ever being directly linked to the resources themselves.

As evidenced from the examples above and as will be explained in more detail below, some of the techniques described in this disclosure facilitate managing multiple users and resources in a media playback system by associating them in a way that allows for access to be granted explicitly and implicitly. This allows the most current state of the system to be considered to control access, without having to manually update any explicit grants.

In some embodiments, for example, a computing device is provided. The computing device comprises at least one processor, and at least one non-transitory computer-readable medium comprising program instructions that are executable by the at least one processor such that the computing device is configured to: receive, from a main account associated with a media playback system, an invite request to invite an additional account to access a set of one or more resources of the media playback system; based on the invite request, generate, via a first service a first association, wherein the first association comprises an association between the additional account and one or more of: (i) the main account, or (ii) the set of one or more resources; after generating the first association, receive, from a user device associated with the additional account, an access request to access at least one functionality for a particular resource in the media playback system; based on a determination that the first association does not comprise an association between the additional account and the particular resource, query a second service to obtain data corresponding to a second association, wherein the second association comprises an association between one or more of: (i) the main account and the particular resource, or (ii) the set of one or more resources and the particular resource; and based on both the first association and the second association, allow the additional account to access the at least one functionality for the particular resource.

While some examples described herein may refer to functions performed by given actors such as “accounts”, “users,” “listeners,” and/or other entities, it should be understood that this is for purposes of explanation only. The claims should not be interpreted to require action by any such example actor unless explicitly required by the language of the claims themselves.

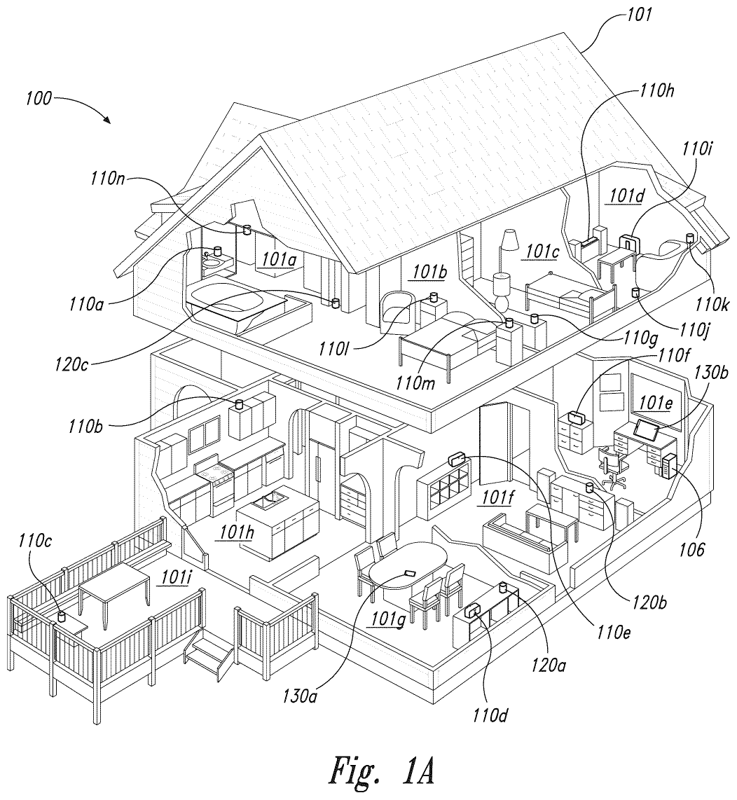

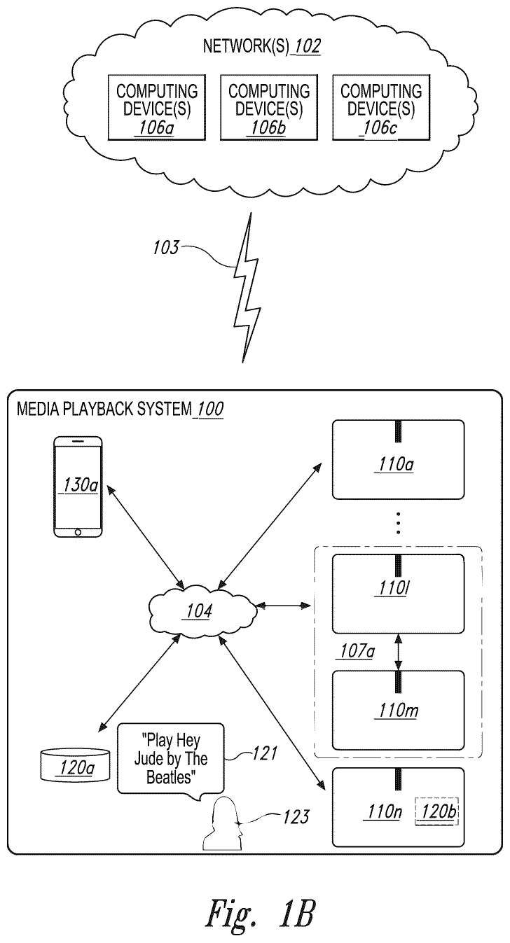

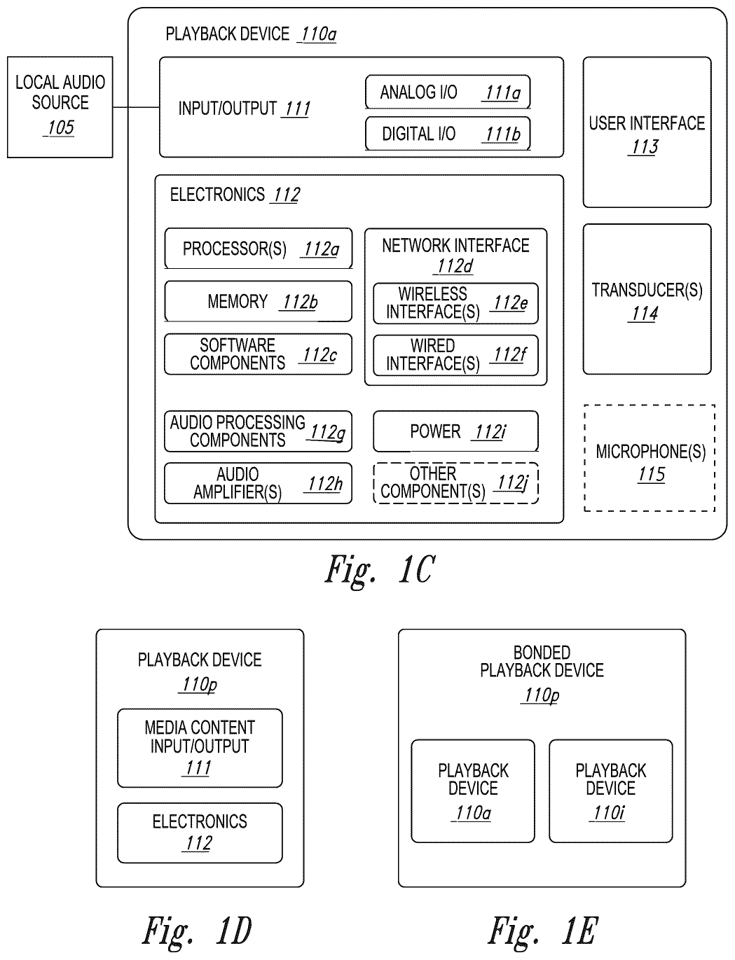

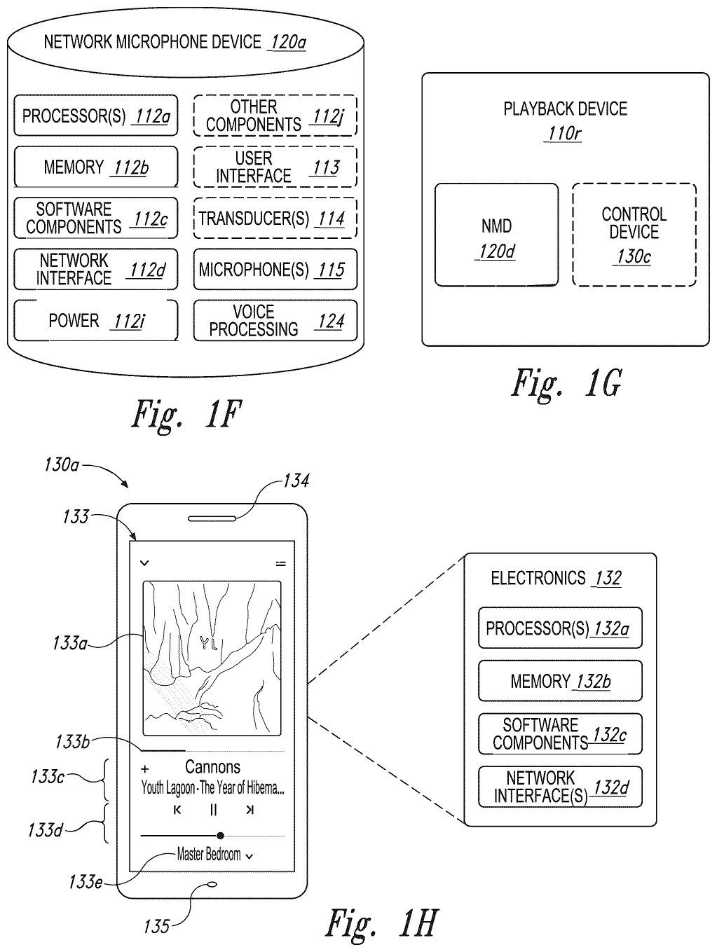

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For case of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112c. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-car earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Multi-User Media Playback Systems

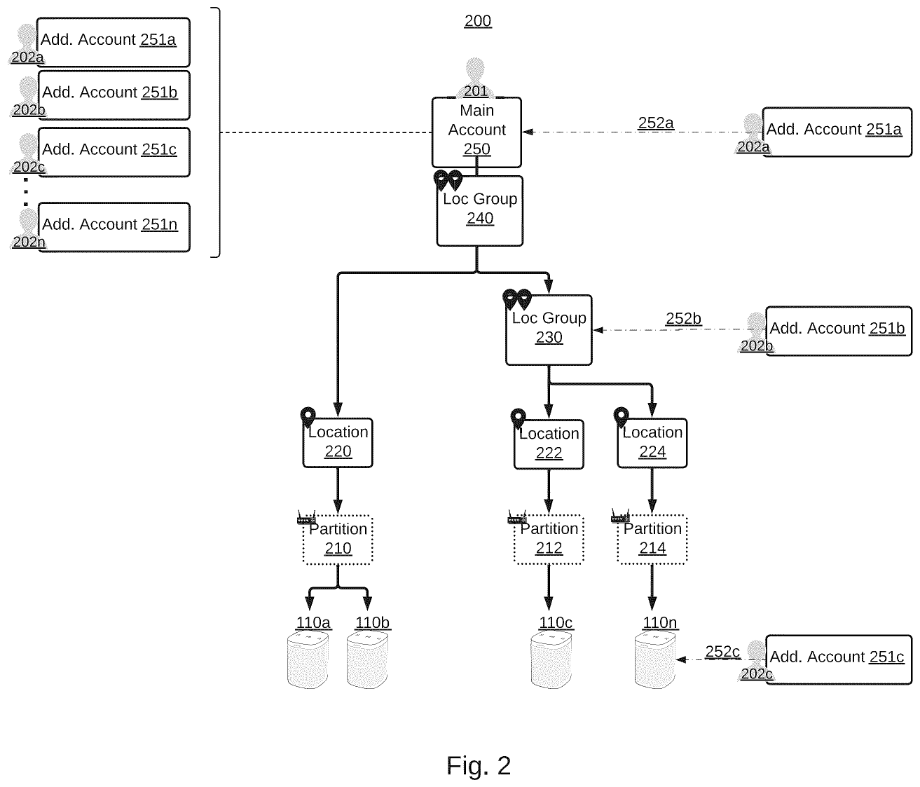

FIG. 2 includes a diagram 200 illustrating an example representation of a media playback system topology, in accordance with embodiments described herein. In some instances, the media playback system can be the same or similar to any of the media playback systems 100 described with reference to FIGS. 1A-1H. In some instances, the media playback system can be the same or similar to any of the media playback systems described in U.S. Provisional Application No. 63/459,882, filed Apr. 17, 2023, and titled “Management of Media Playback System Splits and Location Designation for Partitions of a Media Playback System” and U.S. patent application Ser. No. ______, filed Apr. 15, 2024 and titled “Management of Media Playback System Splits and Location Designation for Partitions of a Media Playback System” (filed concurrently as Attorney Docket Number 22711.11), the contents of each of which are incorporated by reference in their entirety. In some instances, the media playback system can be the same or similar to any of the media playback systems described in U.S. Provisional Application No. 63/459,897, filed Apr. 17, 2023, and titled “Media Playback System Switcher”, and U.S. patent application Ser. No. ______, filed Apr. 15, 2024 and titled “Media Playback System Switcher” (filed concurrently as Attorney Docket Number 22711.13), the contents of each of which are incorporated by reference in their entirety.

The media playback system can comprise any number of playback devices, such as playback devices 110a, 110b, 110c, . . . 110n (collectively referred to as playback devices 110). In some instances, the multi-user media playback systems described in this disclosure can comprise (or be split into) two or more partitions (e.g., partitions 210, 212, 214). A partition, as used herein, refers to a set of one or more playback devices that are connected to the same LAN. In this way, the media playback system can be said to be split when one or more playback devices are connected to a different LAN(s) than other playback devices in the media playback system. In some instances, when playback devices are in different partitions, they can be considered to be in different locations (e.g., locations 220, 222, 224). In some instances, two or more partitions of the media playback system can be associated with a same location. A “location”, as used herein, refers to and/or identifies a collection of playback devices, regardless of the actual physical location where the devices are at and/or the LAN to which the devices are connected. It should be understood that the term “location”, as used in this disclosure, does not indicate a particular place or position. To avoid confusion, the term “physical location” or “place” will be used, if necessary, to refer to a particular place or position. Additional details regarding system's partitions and locations can be found in U.S. Provisional Application No. 63/459,882, filed Apr. 17, 2023, and titled “Management of Media Playback System Splits and Location Designation for Partitions of a Media Playback System” and Ser. No. ______, filed Apr. 15, 2024, and titled “Management of Media Playback System Splits and Location Designation for Partitions of a Media Playback System” (filed concurrently as Attorney Docket Number 22711.11).

In some instances, locations can be grouped in location groups (e.g., location group 230). Location groups can in turn be grouped with other location groups and/or other locations (e.g., location group 240). In this way, a media playback system can be organized in accordance with a hierarchical topology comprising multiple levels and branches. The example topology illustrated in FIG. 2 is for illustrative purposes only. Any number of nodes (e.g., playback devices, partitions, locations, location groups, etc.) can exist for a media playback system in accordance with this disclosure. Furthermore, each partition/location can include any number of playback devices.

As illustrated in FIG. 2, the media playback system can be registered with a main account 250. The main account 250 can be associated with (e.g., belong to) a user 201. In some instances, user 201 can comprise any type of entity such as a person, a business, a company, etc. The media playback system can be registered with the main account so that the media playback system and all constituent resources (e.g., playback devices 110a, 110b, 110c, . . . , 110n, collectively referred to as playback devices 110) are associated with/mapped to such main account. This association can be created by having a system identifier associated with the main account assigned to each device in the media playback system to register the device to the main account. Example registration procedures are described in U.S. Patent Pub. No. 2022/0104015, filed Sep. 24, 2021, entitled “Intelligent Setup for Playback Devices”, which is incorporated by reference in its entirety.

The media playback system (and/or associated main account 250) can be configured in such a way that allows additional accounts (such as additional accounts 251a, 251b, 251c, . . . , 250n, collectively referred to as additional accounts 251) to be associated with the media playback system (and/or the main account 250). The additional accounts 251 can be associated with (e.g., belong to) respective users 202a, 202b, 202c, . . . , 202n, collectively referred to as additional users 202. In some instances, one or more of the users 202 can comprise any type of entity such as a person, business, a company, etc.

In some instances, additional accounts can be associated with the media playback system by being associated with the main account. In some instances, additional accounts can be associated with the media playback system by being (additionally or alternatively) associated with the media playback system itself (e.g., by associating the accounts with a media playback system identifier). In some instances, additional accounts can be associated with specific resources within the media playback system such as locations and/or playback devices (e.g., by associating the accounts with identifiers of the locations or playback devices).

The main account can be configured to view and manage the additional accounts in the system. In some instances, the main account can manage information about all additional accounts associated with the system, the specific resources the additional accounts have access to, their role in the media playback system, etc. The main account can also have options to add (e.g., invite) and/or remove additional accounts to and/or from the system.

Each additional account can be configured to individually access/manage the set of media playback system resources to which they have access. In some instances, the additional accounts can access/manage such resources based on an assigned role. The role can define specific permissions on the resources accessible to the additional accounts. For example, an additional account may be granted explicit access to a resource such as a playback device. A role for the additional account could define that the account is authorized to perform only certain operations or control certain functionalities (e.g., start/stop playback), but not others (e.g., select content for playback). In this way, there can be multiple levels of access control and/or permissions verification to determine what a particular account is authorized to do in a system. One such level could be based on any explicit/implicit grants to the additional account to determine what resources the additional account is authorized/not authorized to access. Another such level could be based on any role to determine what functionalities the account is allowed to access/control for the resources to which the account does have access.

In some instances, the additional accounts can access/manage resources using an access token. The access token can be specific to the account and/or to the resources the accounts have access to. In some instances, the token identifies the account and/or user (e.g., a userId). The token can be a trusted means of identifying and/or authenticating the account/user (they are who they say they are). Furthermore, the token can identify a role for the account such that each additional account can access the resources it has been granted to subject to any respective role for the additional account. In some instances, the token identifies the account/user itself but not necessarily the role of the account/user, and the account/user can in turn have been assigned the role. In some instances, the main account uses a main account access credentials and/or token to perform some or all functions related to the main account. These credentials/token can be different from any other credentials/tokens in the system, such as from any credentials/token used by any of the additional accounts. Example mechanisms for access control based on tokens and roles are described in U.S. Pat. Pub. No. 20220360585, filed May 9, 2022, entitled “Authorization Management in a Media Playback System”, which is incorporated by reference herein in its entirety.

As explained before in this disclosure, in some instances the additional accounts can be granted explicit permission (explicit grants) to access particular resources in the media playback system (e.g., playback device(s), location(s), location groups(s), etc.). For example, the main account could define the particular resource(s) by identifying the particular resources (e.g., using some kind of resource identifier, such as a location identifier or playback device identifier), and associate the resource identifiers with the corresponding additional account. An explicit association between such particular resources and the additional account being granted access to them can be stored and relied on every time the particular account attempts to access any resource in the system. If the additional account attempts to access an explicitly granted resource, the system can easily determine that the additional account has access to the resource based on the stored explicit association. The system can then proceed accordingly (e.g., grant access, verify a role for the additional account so that access can be granted based on the role, etc.).

Examples of explicit grants/associations are illustrated in the example of FIG. 2 with reference to arrows 252a, 252b and 252c. In a first example (arrow 252a), additional account 251a is illustrated as having explicit access to main account 250. In this case, additional account 251a could have access to the same resources and/or same level of privileges as main account 250, subject to any role established for the additional account 251a. In a second example (arrow 252b), additional account 251b is illustrated as having explicit access to location group 230. In this case, additional account 251b could have access to any resources in location group 230, subject to any role established for the additional account 251b. In a third example (arrow 252c), additional account 251c is illustrated as having explicit access to playback device 110n. In this case, additional account 251c could have access to only playback device 110n, subject to any role established for the additional account 251c.

As also explained before in this disclosure, in some instances the additional accounts can be granted implicit permissions to access particular resource(s) in the media playback system (implicit grants). The implicit permissions can be based on the explicit permissions and/or other additional data/associations available to the media playback system. For example, a relationship of media playback system's resources can be used to determine whether a particular account/user has implicit access to a particular resource. Similarly, a relationship of the additional account to other accounts (e.g., the main account) could be used for similar purposes.

The additional data/associations used to determine any implicit grants can comprise, for example, a topology of the media playback system. The topology of the media playback system can comprise a list of resources and the relationship between any of the resources (e.g., all playback devices, all locations, groups of locations, etc.) in the media playback system. In this way, when an additional account is explicitly granted access to a particular resource (e.g., a location), the system's topology can be used to determine any implicit grants that the additional accounts may have on any resources associated with the explicitly granted resource (e.g., playback devices in the location). In some instances, the topology can be dynamically updated to reflect the most recent state of the media playback system. In these cases, any implicit grant of resources in the system could change dynamically to reflect the topology changes as resources are added, moved, or removed in the system.

Using the example explicit grant described with reference to arrow 252b in FIG. 2 as an example, additional account 251b could have implicit permissions on resources under location group 230, such as locations 222 and 224, and any corresponding playback devices such as playback devices 110c and 110n. Similarly, based on the example explicit grant represented by arrow 252b, additional account 251b may not have access (neither explicit nor implicit) to resources in the system outside of the set of resources mapped to and/or associated with the explicitly granted resources. For example, additional account 251b may not have access to location group 240 as a whole, since it corresponds to a higher level/parent node in the topology's hierarchy. As another example, additional account 251b may not have access to location 220 or any of its associated playback devices, since it represents a different, independent branch in the topology. An additional account with explicit access to location group 240 could, however, have implicit access to any of the locations 220, 222 and 224, and corresponding playback devices.

The additional data/associations used to determine any implicit grants could additionally or alternatively comprise a hierarchy (or any relationship) of accounts associated with the system. For example, an additional account, such as additional account 251n, could be mapped to another account, such as additional account 251b, so that additional account 25 In is explicitly associated with additional account 251b and implicitly granted access to any corresponding resources. Additional account 251b, in turn, could have been explicitly associated with another account rather than with location group 230. For example, additional account 251b could have been explicitly associated with the main account 250 (e.g., granted explicit access to any resources accessible to the main account 250) subject to any role for the additional account 251b. In this case, additional account 25 In could have an implicit association with the main account 250 by being explicitly associated with additional account 251b, and therefore may have implicit permissions on any resources associated with the main account, subject to any role for the additional account 251n.

The additional data/associations used to determine any implicit grants could additionally or alternatively comprise a relationship or association of additional accounts in the system with resources in the system. Still using the example above in which an additional account (such as additional account 251n) has been explicitly associated with another account (such as additional account 251b), an association of additional account 251b to any resources to which additional account 251b has access to could be used to determine implicit grants for additional account 251n.

The additional data/associations used to determine any implicit grants could additionally or alternatively comprise any additional explicit and/or implicit grants. In this way, a first additional account could be granted explicit access to a specific resource (e.g., additional account 251b is granted explicit access to location group 230). A second additional account could in turn be explicitly associated with the first account and/or granted explicit access to any resource associated with the first account (e.g., additional account 25 In could be explicitly associated with additional account 251b). In this case, based on the explicit association between the second additional account 25 In and the first additional account 251b, and based on the additional explicit association between the first additional account 251b and resources including location group 230, it could be determined that the second additional account 25 In has implicit granted permissions to access location group 230.

In some instances, a chain of access can be established so that additional users/accounts are allowed to grant access to other additional accounts (e.g., if a role for the accounts allows them to do so). In some instances, this chain of access could be established so that users/accounts are able to grant access to resources that they “own” and/or have been granted access to, but not to affect access to anything “owned” by the accounts that granted the access in the first place and/or that ultimately “owns” the resource. In this way, accounts in the system be allowed to grant access only to resources that they have been granted access to. In this way, when a first account is explicitly associated with a second account without specifying any specific resources, the second account could have implicit access to any of the resources that the first account has access to, but not other resources. In some instances, when a new additional account is added to the system, the chain of access can be determined based on the chain/hierarchy of users and resources of the system.

The additional data/associations used to determine any implicit grants could be independent from any data corresponding to the explicit grants. This data could be stored and/or managed by independent services and accessed when needed via service interfaces such as Application Programming Interfaces (APIs). The additional data could dynamically reflect changes to many aspects of the system, such as to the system's topology and/or components/resources. Relying on such additional data to determine implicit grants rather than directly granting explicit permissions for all resources to be accessible to a given account could guarantee that the most up to date system state is being considered when determining whether a particular user/account can access a given resource, rather than having to manually change permissions for users when there are changes to the system.

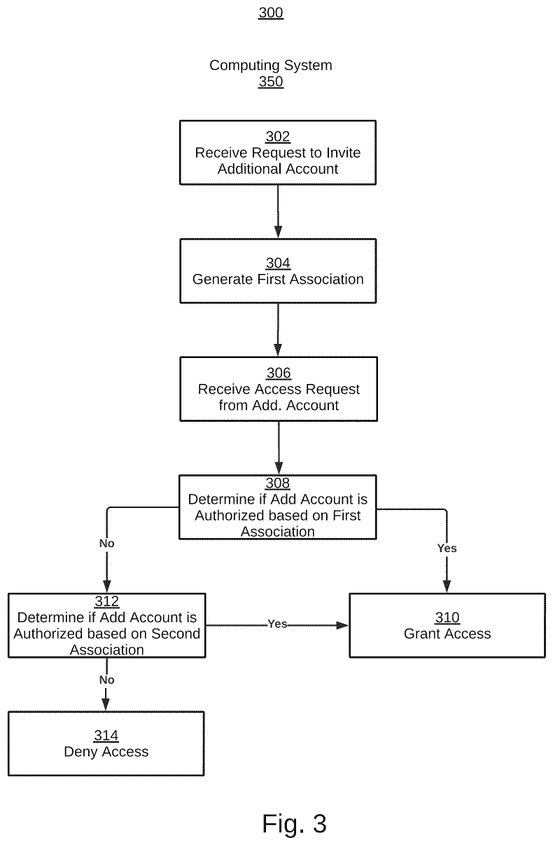

FIG. 3 includes a flowchart for a set of example methods that can be performed by a computing system 350, in accordance with embodiments described herein. The computing system 350 can comprise one or more computing devices. The computing devices can be any device comprising one or more processors and non-transitory computer-readable media comprising program instructions that are executable by the one or more processor such that the computing system is configured to conduct the methods described herein.

In some instances, the computing devices comprise a user device, such as a smart phone or computer. In some instances, the computing devices comprise any of the devices in the media playback system, such as a control device, a playback device, etc. In some instances, the computing devices comprise a remote computing device such as a remote server and/or cloud computing device. In some instances, the computing devices can be any of the computing devices 106 described with reference to FIGS. 1A-1H. In some instances, the computing system 350 comprises any one or combination of computing devices described above or anywhere else in this disclosure. In some instances, the computing system comprises one or more user devices registered with and/or with access to a main account, one or more user devices registered with and/or with access to an additional account, and optionally one or more intermediary devices such as one or more computing systems.

Method 300 includes a block 302 of receiving an invite request to invite an additional account to access at least some resources and functionalities of the media playback system. The invite request can be received from a main account associated with the media playback system such as main account 250 described with reference to FIG. 2. The invite request can be received in various ways. For example, the invite request can be received by/via a user device registered or otherwise having access to the main account (e.g., a device via which the main account can be accessed). The invite request can be received based on an input such as an input received via a user interface of a device with access to the main account. The invite request could also or alternatively be received based on a request from the additional account to be invited to the system.

For example, a device, via the additional account, could scan a QR code provided by the main account to request access to the system.

In some instances, the invite request can include data identifying the additional account, such as an e-mail address associated with the additional account, a phone number for text messages and calls, etc. In some instances, the invite request can include data identifying a role for the additional account in the media playback system. In some instances, the invite request can include data identifying one or more resources to which the additional account is to be granted explicit access to. For example, the invite request could identify a group of one or more partitions/locations of the media playback system (e.g., a location group such as location group 230 in FIG. 2). The resources could be identified by a single identifier corresponding to the group of resources (e.g., an identifier for location group 230) and/or by a list of identifiers corresponding to one or more resources within the group of resources (e.g., one or more identifiers for locations 222 and location 224, and/or one or more device identifiers of any playback devices in the location group, such as playback devices 110c and 110n).

Method 300 includes a block 304 of generating a first association. The first association can be generated based on the invite request received in block 302. The first association can correspond to any explicit grants/permissions given to the additional account. For example, the first association can comprise an association between the additional account and one or more of the main accounts and/or any resources identified in the invite request, such as the group of one or more locations/partitions of the media playback system (e.g., location group 230 in the previous example). The first association can be generated when/after the invite request is received in block 302 and/or upon acceptance of any corresponding invite by the additional account. Other scenarios are possible.

Generating the first association can include creating a data structure and/or an entry in a data structure (e.g., a table, database, etc.) comprising a set of data corresponding to the different elements being associated. For example, the data structure can include identifiers for one or more of the main accounts, the additional account, any resources identified in the invite request, a role of the additional account, a status such as whether the invite process is pending or accepted/completed, rejected, expired, etc. The first association can be stored in one or more first data storages accessible to the computing system (e.g., locally on a user device with access to the main account, on a playback device or other device of the media playback system, and/or a remote data storage, etc.).

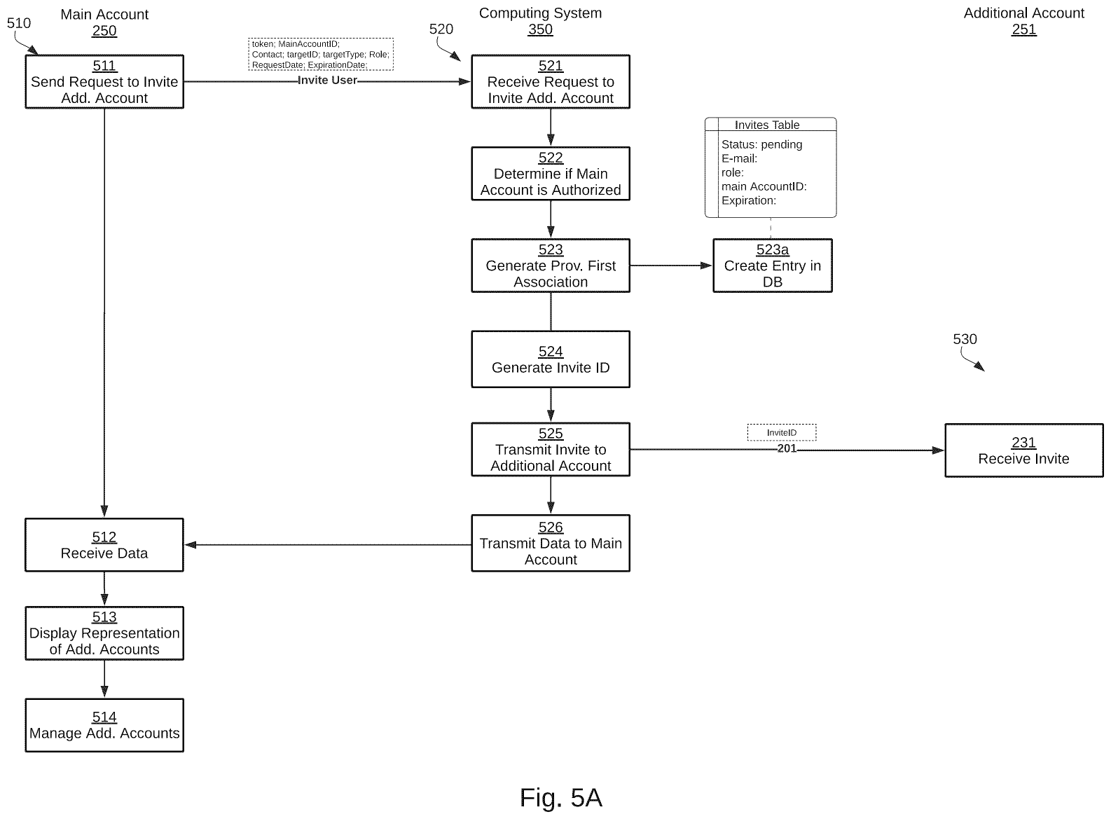

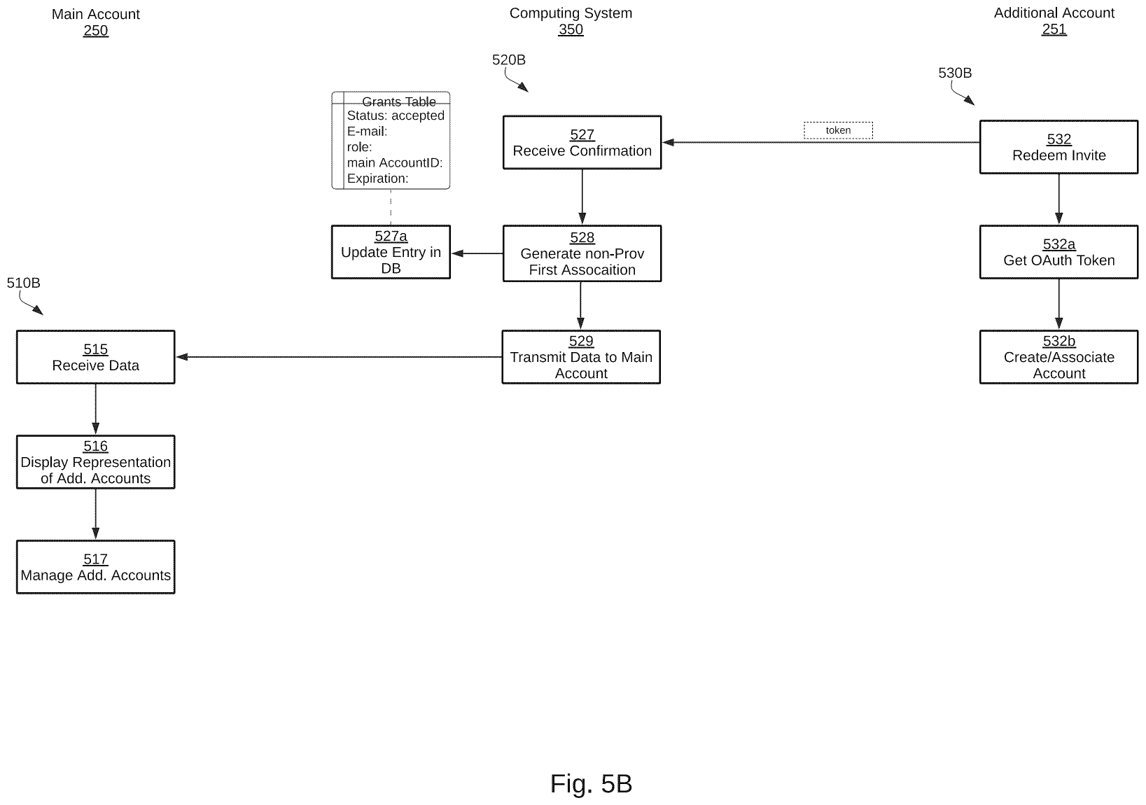

In some instances, generating the first association in block 304 comprises generating two or more associations. For example, if the invite request identifies various resources to which the additional account is being granted access, separate associations can be generated to map, for example, the additional account to the main account and the additional account to any of the resources indicated in the invite request. Additionally, multiple instances/versions of the first association can exist before a final first association is generated and stored. For example, and as will be explained in more detail below with reference to FIGS. 5A and 5B, a pending or provisional first association can be generated first and then a non-provisional or final first association can be defined based on additional data. For example, block 304 can include first generating the provisional or pending association. The computing system can be configured to receive some confirmation from any of the additional account and/or main account to then create the non-provisional or final association.

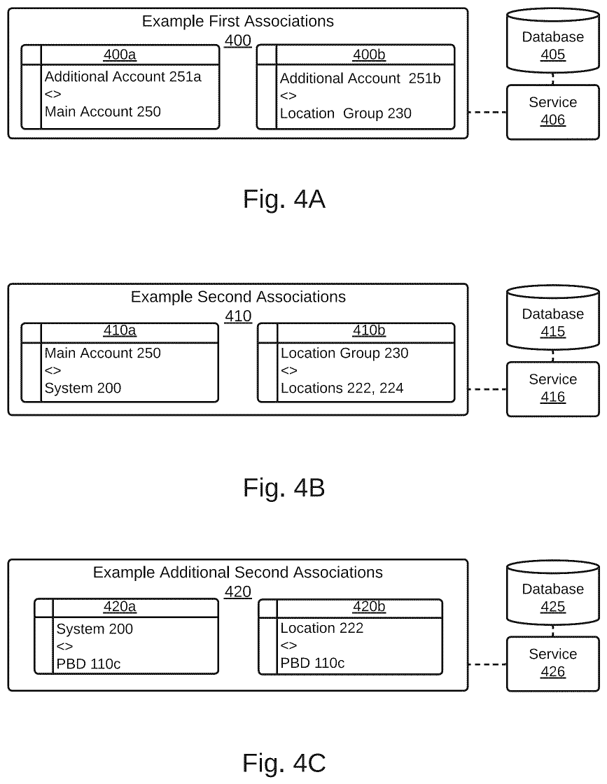

FIG. 4A includes a diagram of example first associations 400. These example first associations can correspond to the explicit grants described in FIG. 2 with reference to arrows 252a and 252b. In the first example association 400a the additional account 251a is associated with the main account 250. In the second example association 400b the additional account 251b is associated with location Group 230. Associations 400a and 400b can be generated by storing account identifiers and resource identifiers in the respective data structures 400a and 400b. Data structures 400a and 400b can include other additional data such as role, expiration date, status, etc., as will be explained in more detail with reference to FIGS. 5A and 5B.

As illustrated, the example first associations 400 can be stored in a database 405 and/or managed by a service 406. Service 406 could be provided by one or more computing devices in the computing system 350. In some instances, the example first associations are stored and/or managed by the device that generated them. For example, if the associations are generated by a user device with access to the main account, the associations can be stored and managed by the user device. As another example, if the associations are generated by a server, the associations can be stored and managed by the server. In some instances, associations can be shared with (e.g., sent to/accessible by) other devices in the media playback system, regardless of where they were generated.

With reference back to FIG. 3, method 300 includes a block 306 of receiving an access request associated with the additional account to access one or more functionalities for a particular resource in the media playback system (e.g., a particular group of one or more partitions/locations in the media playback system, a particular playback device, etc.). The access request can be received, for example, by/from/via a user device registered with and/or with access to the first additional account. The access request can be received based on an input received via the first account to, for example, control the functionality for the resource. For example, the access request can be received based on a playback command such as a command to stop/start playback for the particular location group or the particular playback device received via the additional account. The access request can include data such as an identifier of the additional account, an identifier of the particular resource that the additional account desires to access, an access token, a command or instruction to be executed by the particular resource, etc.

In some instances, the access request can be received by/from/via any device in the media playback system. For example, the access request can be received by/from/via a playback device that the additional account is attempting to access. The playback device may receive a command from a device registered with the additional account. The command could include data identifying the additional account, such as an identifier of the additional account, an access token of the additional account, etc. The playback device could then carry out the following blocks of method 300, and/or communicate with an additional device to carry out at least some of the following blocks of method 300.

Method 300 includes a block 308 of determining whether the additional account is authorized to access the resource that it is attempting to access (i.e., the resource identified in the access request). This determination can be made based on the first association, generated in block 304. For example, any explicit permissions granted to the additional account can be verified. If it is determined that an association between the additional account and the particular resource it is trying to access is present in the first association (e.g., if the first association comprises an association between the additional account and the particular resource), the computing system can grant the additional account access to the particular resource, as indicated by block 310. With reference back to the example in FIG. 2 and example first associations in FIG. 4A, one example of this situation could be if account 251b attempts to access the location group 230. For example, user 202b may attempt to start playback for location 230. Because the explicit association 400b already exists, the system can grant the request (e.g., allow the account/user to access the resource, verify a role for the account to see if the account is authorized to start playback, etc.).

Block 310 of FIG. 3 could include the computing system forwarding any commands received from the first account for execution by the corresponding resource of the media playback system. Block 310 could also include the computing system executing any commands received from the first account if the computing system is/comprises the corresponding resource (e.g., the playback device). Block 310 could include sending one or more messages to the computing system (e.g., to the resource the user is trying to access) confirming that the account/user is allowed to access the resource.

The computing system can grant access by allowing/authorizing the additional account or corresponding device to execute any command and/or control any functionality, subject to any role established for the additional account. At this point, the computing system, upon determining that the additional account has access to the particular resource, could proceed to determine a role for the account on the particular resource to then determine whether the account has permissions to access the functionality it is trying to access for the particular resource.

If it is determined in block 308 that an association between the additional account and the resource it is trying to access is absent in the first association (i.e., if it is determined that an explicit grant for the particular resource does not exist for the additional account), the computing system could determine that the additional account is not authorized to access the particular resource, based on the first association. In this case, the computing system could deny access to the resource. However, in some instances, the computing system could proceed to determine if the additional account has access to the resource based on one or more second data/associations, as indicated by block 312.

The second data/association can be any other data/association available to the computing system that could be used to determine, for example, any implicit grants for the additional account. The second data/association can comprise any of the additional data/associations used to determine any implicit grants discussed with reference to FIG. 2. For example, the second association can comprise an association between the main account and the particular resource that the additional account is attempting to access, or between a set of resources and the particular resource. In this way, based on a first association that explicitly associates the additional account to one or more of the main accounts and/or the set of resources, the second association(s) can be used to determine that the additional account has been implicitly granted access to the particular resource.

FIG. 4B includes a diagram of example second associations 410. These example second associations can correspond to the implicit grants described with reference to FIG. 2. In the example second association 410a the main account 250 is associated with the system 200. This association can be generated via a system identifier associated with the main account, and stored in association with a main account identifier. From this association, it can be determined that the main account 250 has access to the whole system 200. Contrasting this information with the explicit grant in example first association 400a it can then be determined, at block 312 of method 300, that the additional account 251a has implicit access to the system 200, via its explicit association with main account 250.

In the example second association 410b, the location group 230 is shown associated with locations 222 and 224. This association can be a representation of a portion of a system's topology as stored by the computing system. From this association, it can be determined that locations 222 and 224 are part of location group 230. Contrasting this information with the explicit grant in example first association 400b it can then be determined, at block 312 of method 300, that the additional account 251b has implicit access to locations 222 and 224, via its explicit association with location group 230.

As illustrated, the example second associations 410 can be stored in a database 415 and/or managed by a service 416. Service 416 could be provided by one or more computing devices in the computing system 350. In some instances, the example second associations are stored and/or managed by the device that generated them. For example, if the associations are generated by a server that manages the system's topology, the associations can be stored and managed by the server. In some instances, associations can be shared with (e.g., sent to/accessible by) other devices in the media playback system, regardless of where they were generated. In some instances, one or more of database 415 and/or service 416 are different and independent from one or more of database 405 and/or service 406 storing and managing the first associations. These services can communicate and obtain data from each other via any communication channel. In some instances, the services communicate via APIs. As explained for FIG. 4A, data structures 410a and 410b can include any other additional data.

The second association can be completely independent from the first association. For example, the second association can be stored in one or more different data storages and/or managed by one or more different services. The computing system may then need to query these data storages as part of the determination in block 312. The second association may be managed by a different computing system, and/or a different service provided by the computing system which is different from the service that provides the first association. The computing system may then use different means to obtain data from the first and/or second association, such as different APIs, commands, and/or messages exchange.

The computing system can determine, based on the second association, whether to grant/allow (block 310) or deny (block 314) access to the particular resource. If an implicit grant is found based on one or more second associations, then it can be determined that the additional account is authorized to access the particular resource and the account can be allowed to access such resource based on any corresponding role. If an implicit grant is not found, the computing system can deny/prevent access of the additional account to the particular resource. Denying/preventing access can include ignoring/rejecting any commands received from the additional account for the particular resource. Denying/preventing access can include sending a message to the additional account indicating that the additional account does not have access to the particular resource. Denying/preventing access can include sending a message to the main account indicating that the additional account is attempting to access a resource for which the additional account has not been granted permissions. Denying/preventing access can include sending a message to the media playback system (e.g., to the resource the account is trying to access) indicating that the account is not authorized to access the resource.

The number of intermediary associations that can be analyzed in block 312 to determine the implicit grants can be predefined or indefinite. For example, the computing system could be configured so that it queries data structures for data a certain number of times and uses the data obtained to continue querying the same or other data structures for related data. As the number of resources in a media playback system increases, the number of data structures and respective queries needed to obtain an implicit grant may become significantly large. For example, for a media playback system with a large number of nodes in its topology and/or levels in the system's hierarchy of resources, an implicit grant of a particular additional account to a playback device can be determined based on many intermediary associations and/or explicit grants between the particular account and other resources/accounts that are ultimately associated to the playback device of interest in the given example.

FIG. 4C includes a diagram of example additional second associations 420. These examples of additional second associations can correspond to the implicit grants described with reference to FIG. 2. In the example additional second association 420a the system 200 is associated with a specific resource (playback device 110c illustrated in this example, but can include a list of any/all devices/resources in the system). This association can be generated by generating and storing an association between resource identifiers and the system identifier. From this association, it can be determined that the system 200 includes the playback device 110c. Contrasting this information with the explicit grant in example first association 400a and the implicit grant in the example second association 410a, it can then be determined, at block 312 of method 300, that the additional account 251a has implicit access to the playback device 110c, via its explicit association with main account 250 and further implicit association with system 200. In this way, if a user of additional account 251a attempts to access (e.g., sends a command to) the playback device 110c, the computing system could determine that the user/additional account is authorized even when an explicit grant to this resource does not exist.

In the example additional second association 420b the location 222 is associated with a specific resource (playback device 110c illustrated in this example, but can include a list of any/all devices/resources in the location). This association can be a representation of a portion of a system's topology as stored by the computing system. This association can be generated by generating and storing an association between resource identifiers and the location identifier. From this association, it can be determined that the location 222 includes the playback device 110c. Contrasting this information with the explicit grant in example first association 400b and the implicit grant in the example second association 410b, it can then be determined, at block 312 of method 300, that the additional account 251b has implicit access to the playback device 110c, via its explicit association with location group 230 and further implicit association with location 222. In this way, if a user of additional account 251b attempts to access (e.g., sends a command to) the playback device 110c, the computing system could determine that the user/additional account is authorized even when an explicit grant to this resource does not exist.

As illustrated, the example additional second associations 420 can be stored in a database 425 and/or managed by a service 426. Service 426 could be provided by one or more computing devices in the computing system 350. In some instances, the example additional second associations are stored and/or managed by the device that generated them. For example, if the associations are generated by a server that manages the system's topology, the associations can be stored and managed by the server. In some instances, associations can be shared with (e.g., sent to/accessible by) other devices in the media playback system, regardless of where they were generated. In some instances, one or more of database 425 and/or service 426 are different and independent from one or more of database 405/415 and/or service 406/426 storing and managing the first and second associations. These services can communicate and obtain data from each other via any communication channel. In some instances, the services communicate via APIs. As explained for FIG. 4A, data structures 420a and 420b can include any other additional data.

The examples described above with reference to FIGS. 4A-4C include two ways in which two different additional accounts (251a and 251b) can be implicitly granted access to a same resource (the playback device 110c). Each of the accounts, however, have different levels of access in the system based on their explicit grants and any corresponding implicit grants. For example, additional account 251a may have access to playback device 110a, while additional account 251b may not.

The second associations may have been generated for any purposes and in any different ways than the first association, and can be completely independent from the additional account and/or invite request sent from the main account. As explained before in this disclosure, the second association can include a system topology, a hierarchy of resources, a hierarchy of accounts, or any other association. As also explained before in this disclosure, relying on a second association can be beneficial because it allows the computing system to consider many aspects and changes to the system when making an access determination. Furthermore, the first association can be a more static and/or straightforward association given that the explicit grants can be granted between resources that are less likely to change unless manually changed by, for example, a user of the main account. The second association, however, can be a more dynamic association with resources that can change more frequently or automatically to account for changes to the system.

In some instances, the first association comprises an association between the additional account and elements of the system that are more permanent and/or stable, such as elements that are less likely to change based on underlying changes to the system. For example, the first association could comprise only associations between accounts, but not resources, because the accounts are likely to persist in the system even when there are no resources associated with them. In this case, the first association can be used to determine any accounts that are associated to a particular account, and then determine the resources associated to those accounts based on one or more second associations. The resources associated with the accounts can then change dynamically, but access control can be guaranteed by relying on the resources that are currently mapped to the account.

As explained in U.S. Provisional Application No. 63/459,882, filed Apr. 17, 2023 and titled “Management of Media Playback System Splits and Location Designation for Partitions of a Media Playback System” and Ser. No. ______, filed Apr. 15, 2024 and titled “Management of Media Playback System Splits and Location Designation for Partitions of a Media Playback System” (filed concurrently as Attorney Docket Number 22711.11), locations and/or location groups can be more stable and more permanent nodes in the system's topology, in that they may persist in the system even when the devices associated with a location are moved/removed, and are not likely to change unless there is an explicit user input to do so. Therefore, in some instances, locations can be an example of stable resources in the system. Permanent and/or stable resources can be associated with permanent/stable identifiers that are likewise not likely to change based on underlying system changes. In this sense, in some instances, it can be beneficial to create a first association between the additional account and such stable resources. In this way, the first association exists in the system independent of any physical configuration of the system. For example, if playback devices are added to or removed from the location, an additional account with access to the location would automatically lose/gain access to those playback devices by having access to the location.

With reference back to the examples in FIG. 2, if playback device 110a is moved to location 222, additional account 251b could automatically gain access to this playback device based on the topology change (and its explicit access to location group 230 and implicit access to location 222). If playback device 110c is moved out of location 222 and to location 220, additional account 251b could automatically lose access to this device based on the topology change (and the absence of any implicit grant to location 220).

In some instances, the computing system can monitor and/or detect changes to the system topology in order to make any determinations in block 312 of method 300. In this way, a same additional account could be granted access to a resource in a first instance (e.g., a first attempt to access a resource at a first time), and denied access in a second instance e.g., a second attempt to access the resource at a different time), based on a change to the topology that alters the implicit grants for the additional account. For example, additional account 251b may be allowed to send a playback command to device 110c in a first instance, while playback device 110c is in location 222. However, additional account 251b may be denied access to device 110c in a second instance, after playback device is moved out of location 222 and/or location group 230. In this way, block 312 of method 300 could comprise determining a change in the topology and grant/deny access based on the change.

In some instances, the explicit grants can be changed, lost or no longer valid. For example, explicit grants could no longer be valid because the resource to which the additional account is associated no longer exists within the system (e.g., a location was deleted). In such cases, the system might be configured to prompt the users, via their respective accounts, to notify them about and/or solve for the missing resource and/or establish updated explicit grants. In some instances, any data useful to determine implicit grants can be used to re-associate users to resources if there are changes to the topology that affect explicit grants. For example, the system may be configured to automatically generate or suggest a new explicit grant in which the additional account has access to any resource immediately below the lost/altered resource in the hierarchy of resources and/or system topology.

In some instances, some or all of the associations (e.g., the first associations and second associations) can be stored locally by the devices in the media playback system so that devices are able to make any access determination. For example, a playback device could store data corresponding to the explicit grants so that, when it receives a command associated with an additional account (e.g., from a device registered with the additional account) it can make any determination as to whether to grant or deny access (e.g., the playback device can perform one or more of blocks 306-314 of flowchart 300). In some instances, some or all of the associations are stored by other devices (e.g., by remote server(s)/database(s)). In these cases, the devices in the media playback system could request and/or access the associations in order to make any access determination. In some instances, associations that are less likely to change automatically can be stored locally by the devices in the system (e.g., explicit grants) and associations that may change more dynamically can be requested from a corresponding service (e.g., services 406, 416, 426 in FIG. 4) with a certain frequency (e.g., periodically and/or when an access request is received), to ensure that the most recent system state and configuration is being considered when determining access to a resource. In some instances, any access requests (e.g., commands, messages, etc.) to any devices in the media playback system are received/routed by the computing system so that the computing system can make the access determination before forwarding the request to any device in the media playback system.

FIG. 5A includes a set of flowcharts 510, 520 and 530 for a set of example methods of inviting additional accounts to access a media playback system, in accordance with embodiments described herein. Method 510 can be performed by/via a main account such as main account 250 and/or by any device with access to the main account, such as a user device of a user of the main account. Method 520 can be performed by a computing system such as computing system 350. In some instances, some or all of the blocks in method 520 can be permed by the same device that performed method 510 (e.g., a user device via which the main account can be accessed). In some embodiments, the computing system comprises other devices such as playback devices, servers and/or cloud computing devices. Method 530 can be performed by any one or more additional accounts, such as additional accounts 251, and/or any device with access to the main account, such as a user device of a user of the additional account.

In some instances, some or all of the steps of method 510 can be performed by any device registered with the main account and/or any device through which such additional account can be accessed. In some instances, the main account can be accessed via a user device such as a smartphone, a computer, etc. For example, the main account could be accessed using a set of credentials or other authentication mechanisms, via an application installed on the user device. As another example, the main account can be accessed via a web portal/web interface. Accessing the main account could provide the user with access to a dashboard or other interface via which a user can interact with a media playback system, manage additional accounts, and/or cause the user device to conduct any of the blocks of the method described herein.

Method 510 includes a block 511 of sending a request to invite an additional account. In some instances, this block can be conducted based on one or more inputs received, via the main account, to invite the additional account. For example, an input could be received via a user interface with a selectable indication that, when selected, causes the user interface to display options to complete an invite process. The inputs can indicate data corresponding to the additional account to be added (e.g., an identifier and/or address of the account such as an e-mail address). The inputs can also indicate a role for the additional account. The role can include any role among a plurality of predefined roles including super admin, admin, employee, guests, etc. The inputs can also indicate the resources in the media playback system that the additional account is being granted permissions on.

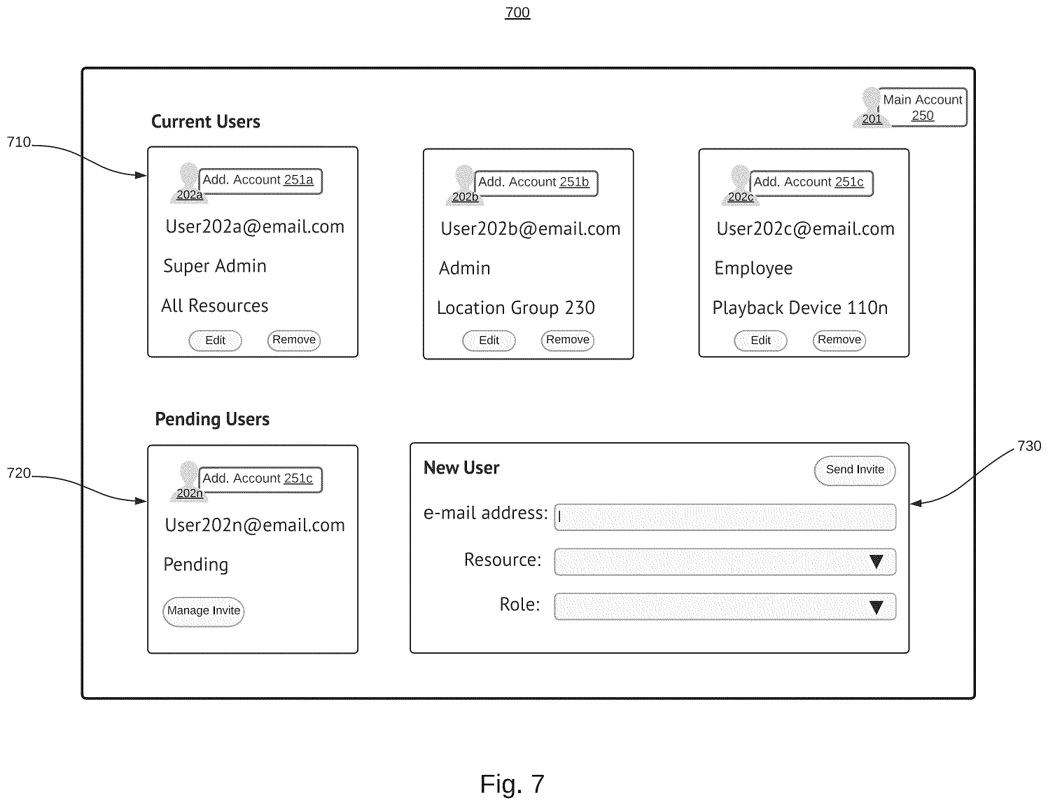

FIG. 7 includes an example graphical user interface associated with the main account, in accordance with embodiments described herein. This graphical user interface can be displayed by any device with access to the main account, via, for example, an application running on the device, a web page, etc. As illustrated, the interface can include an invites region 730 with a selectable indication to invite a user/account. Data associated with and/or identifying the additional account (e.g., email address) could be input via this interface. Additionally, any resources and role for the additional account can be established via the user interface. In some instances, resources can be predefined values to be selected. These values can be different for different users/accounts with different levels of access. For example, when a first account (e.g., the main account or an additional account with permissions to invite other additional accounts) invites a new additional account, the values displayed could be filtered so that only resources available to the first account are available to be shared with the new additional account. In this way, any account can invite other accounts to access the resources it has access to, but not necessarily to access resources it does not have access to, provided that a role for the account permits the account to invite other accounts. Similarly, roles can be predefined values to be selected. A given role (e.g., Super Admin) can give an additional account the privileges as the main account on any resources on which the additional account has access. Similarly to the resources values, the values to be displayed for the roles could also be filtered so that only roles with equal or a more limited set of privileges/permissions as the role of the account that is inviting are displayed. In this sense, an account with an “employee” role could be able (if the “employee” role allows it) to invite an account with equal role (e.g., another employee) or with a more limited set of privileges (e.g., a “client” role), but not necessarily would be able to invite an account with higher levels of privileges such as admin or super admin. In this way, the different levels of access and privileges/permissions within the system can be maintained and controlled by maintaining a hierarchy/chain of accounts, resources and/or roles.

With reference back to FIG. 5A, the invite request in block 511 can be sent, in one or more messages, to the computing system 350. The one or more messages can include additional data, such as data corresponding to the inputs received via the user interface during the invite process. In this way, the one or more messages can include data corresponding to an identifier/address for the additional account, one or more resource identifiers identifying the resources on which permissions are being granted, a role for the additional account, etc. In some instances, the one or more messages include a token associated with the account sending the invite request (e.g., a main account access token), which can be used to authenticate the request and to verify that the account sending the invite request is indeed authorized to invite additional accounts. The one or more messages can also include other data such as a main account identifier or identifier of the account sending the invite, an expiration date for the invite, etc.

The computing system 350 can receive the one or more messages corresponding to the invite request in block 521. This block can be the same or similar to block 302 described with reference to FIG. 3. In some instances, the computing system 350 could optionally determine whether the main account is authorized to make such request, as indicated in block 522. This block could include, for example, parsing/verifying an access token in the request to determine whether the token is valid. This block could also include verifying permissions associated with the account/token. For example, consulting a role for the main account/token to determine whether the account is authorized to invite other accounts. If it is determined that the account sending the request is not authorized to make such a request, the computing system can reject and/or ignore the request and/or forgo inviting the additional account. In some instances, an error message or other response can be sent back to the main account in these types of situations.

If it is determined that the account sending the request is indeed authorized to so invite other accounts, a first association can be generated, as indicated in block 523. This block can be the same or similar to block 304 described with reference to FIG. 3. In some instances, the first association generated in block 523 comprises a provisional association between the additional account, the main account, and/or any identified resources. This association can be stored in a data structure together with other data such as any of the data in the invite request. Storing the association can include storing the association in a data storage accessible to the computing system, such as a database. As illustrated in block 523a, storing the association can include creating an entry in a database. This data structure can be in the form of an invites table comprising data for any invites sent to additional accounts. In some instances the data structure only comprises data for pending invites. A status of the invite and/or association (e.g., pending) can be stored in the data structure as well. In some instances, this association is provisional in that it is pending confirmation/acceptance of the invite.

In some instances, the computing system generates an invite identifier (block 524) corresponding to an invite to be optionally sent to the additional account (block 525). The invite identifier can be unique to the invite and serve to identify the association between the main account and the additional account/resources. In some instances, the invite identifier can be stored as part of or otherwise in association with the first association stored in block 523. In some instances, the invite identifier corresponds to a code to be used by the additional account to obtain access to the media playback system. As illustrated, the additional account can receive the invite at block 231. This block could also include receiving the invite identifier/code. In some instances, the invite identifier/code is embedded in the invite itself (e.g., a URL, a QR code, etc.).

The invite can be transmitted in one or more messages via any suitable communication means. In some instances, transmitting an invite as described with reference to the previous blocks of methods 510, 520 and 530 comprises transmitting the invite via e-mail. In other instances, the invite can be transmitted via other means such as via a text message or instant message, by scanning an invite (e.g., an invite code) displayed by a device with access to the main account, etc.

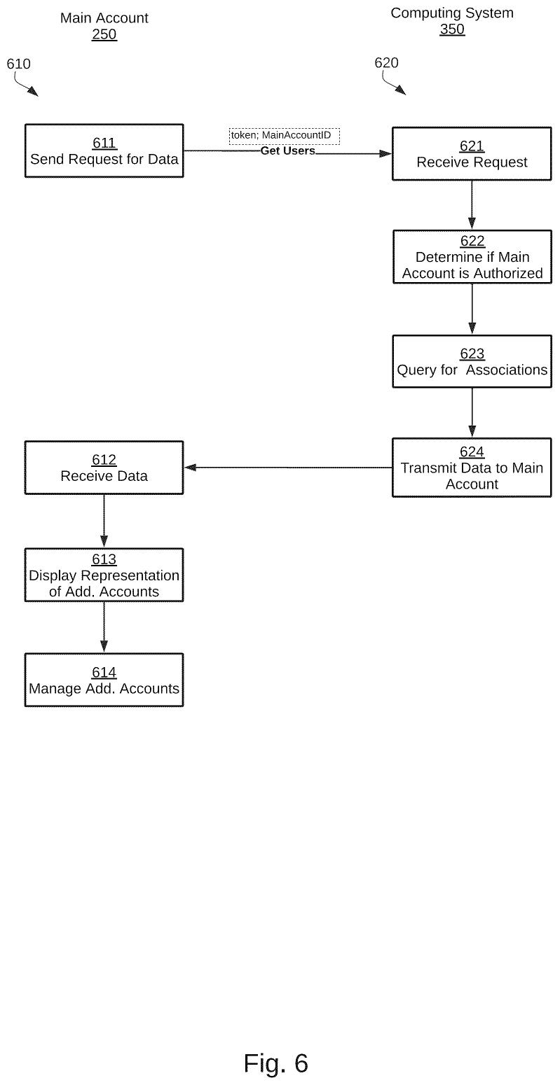

Any data associated with the main account, such as data corresponding to the first association generated in block 523, data corresponding to the additional account, etc., can be optionally sent to the main account (block 526). In some instances, and as will be explained in more detail with reference to FIG. 6, the data can be sent based on a data request received from the main account. The main account can receive the data (block 512) and be able to use the information (e.g., information about any pending invite in the system) for various purposes. For example, the main account, and/or any device with access to the main account, could display graphical representations corresponding to the invited additional accounts, as indicated in block 513. These representations could be displayed as part of a list of representations including pending invited additional accounts or all additional accounts associated with the system (e.g., including additional accounts that have already accepted the invite). Example user interface 700 in FIG. 7 illustrates example graphical representations 710 and 720 corresponding to additional accounts associated with the system.

Once an invite is sent, the main account could also be able to manage the invite and/or any additional account, as indicated in block 514 in FIG. 5A. For example, the main account could be able to withdraw an invite, resend an invite, edit/remove an additional account, etc. The main account may also be able to change any data and/or configuration associated with the invites and additional accounts, such as an e-mail address for the additional account, a role for the additional account, the resources that the additional account is granted access to, etc.

In instances in which the data associated with the invites is stored and/or managed by a service associated with the main account, the main account could request such data to the service, for example via an API. The main account could access/display the representation of the additional accounts by sending a request for invites data and/or additional accounts data to the computing system or any device in the computing system managing such data. A response to such request can comprise a list of additional accounts associated with, or to be associated with, the system. For example, a list of additional accounts in the provisional mapping or association generated in block 523 of FIG. 5A.

FIG. 5B includes a set of flowcharts 510B, 520B and 530B for a set of example methods of adding additional accounts to access a media playback system, in accordance with embodiments described herein. The respective blocks of methods 510B, 520B and 530B could be performed after the processes described with reference to FIG. 5A have been performed (i.e., after an additional account has been invited to access the media playback system).

The additional account could redeem/accept the invite at any time after the invite is sent/received, as indicated in block 532 of flowchart 530B. Redeeming the invite could include selecting an option, on a user interface associated with the additional account, to start an invite acceptance process. The selectable option could be provided with the invite, for example in the form of a link in an invite email received by the additional account. In some instances, the invite acceptance process could be started automatically or based on a trigger once the invite is received (e.g., if a user of the additional accounts scans an invite code provided by the main account). In some instances, the invite includes a URL to a page where the invite acceptance process can be completed.

In some instances, redeeming the invite causes the additional account, or any device via which the invite is being redeemed, to start an authentication and/or authorization process. The process can include obtaining an access token, as indicated in block 532a. The invite can include a URL to the access token or to a process to obtain such access token. In some instances, the process comprises an OAuth flow. In some instances, the process comprises an authentication code flow, in which an authentication code is exchanged for an access token. In some instances, the authentication code can be, or be derived from or obtained via, the invite identifier sent with the invite, generated in block 524 of method 520 in FIG. 5A.

In some instances, redeeming the invite comprises a block 532b of creating the additional account, if it doesn't already exist. For example, the additional accounts can belong to users/entities who may or may not be already users of a media playback system and may therefore not have an account with the media playback system provider. The invite could prompt the user with a user interface that enables them to create the account and/or provide credentials for their accounts, if they already have one. Redeeming the invite could also include associating the additional account to the main account, once it is created. For users that already have accounts with the media playback system provider (e.g., users who already own or are otherwise already associated with a media playback system registered with an existing account), their existing accounts can be associated as the additional account.

The computing system may be configured to receive a confirmation that the invite has been accepted/redeemed, as indicated by block 527 of flowchart 520B. In some instances, such confirmation is received automatically when the user of the additional account accepts the invite. In some instances, the computer system can determine that the additional account has accepted the invite even without receiving any explicit confirmation. For example, the computing device could determine that the additional account has accepted the invite based on data generated/stored as part of the process of accepting the invite by the additional account.

At this point, the computing system could generate a non-provisional first association, as indicated in block 528. In some instances, if a provisional first association was generated in block 523 of flowchart 520 in FIG. 5A, the non-provisional first association generated in block 528 of Flowchart 520B in FIG. 5b can be a non-provisional version of the provisional first association. The non-provisional association can be the same as the provisional association but with at least one update to the set of data stored with the association. For example, a status filed in the association could be changed from “pending” to “accepted” as indicated in block 527a. The non-provisional association could be a different association from the provisional association. For example, the non-provisional association could be a modified copy or version of the provisional association. In some instances, the pending association is stored in a different data storage than the non-provisional association. For example, the provisional association could be stored in a more dynamic data storage where data can be deleted after a certain period of time (e.g., after an expiration date for acceptance of the invite has passed). In any case, after the association (e.g., the non-provisional association) is created and stored, the additional account should have explicitly granted permissions on any resources indicated in the invite request.

Blocks 529, 515, 516 and 517 can be the same or similar to respective blocks 526, 512, 513 and 514 described with reference to FIG. 5A. In this way, any data from the non-provisional association can be sent to the main account so that the main account can display and manage the additional accounts. Example user interface 700 in FIG. 7 illustrates example graphical representations 710 and 720 corresponding to additional accounts associated with the system.

FIG. 6 includes a set of flowcharts 610 and 620 for a set of example methods of requesting and/or sending data regarding additional accounts associated with a media playback system, in accordance with embodiments described herein. Method 610 includes a block 611 of sending, to the computing system, a request for data. The request can be for data associated with the account making the request (the main account in this example). In some instances, the request can be for data corresponding to any additional accounts associated with the account making the request. The request can be sent in one or more messages and comprise a set of data such as a token of the account making the request, an identifier of the account making the request, etc. This request can be made via an API call. An example of such API call is shown as follows:

GET /authz/v1/authorization/users?mainAccountId={{ account_id }}
Headers:
Authorization: Bearer { Token }

An example response to the API call above is shown as follows:

```
Response:
[
  {
      “mainAccountId”: {{businessId1}},
      “users”: [
        {
          “inviteId”: “123e4567-e89b-12d3-a456-426614174000”,
        “firstName”: “Foo”,
        “lastName”: “Bar”,
        “role”: ROLE_ENUM,
        “status”: STATUS_ENUM
        “expirationDate”: YYYY-MM-DD
      },
      ....
    ]
  }
]
```

Method 620 includes a block 621 of receiving the data request. After receiving the request, the computing system could determine whether the account making the request is authorized to do so. The computing system could make such determination based on, for example, the access token included in the request. The computing system could also determine whether the account is authorized to obtain the requested data based on a role for the account.

If it is determined that the account is authorized to make such a request, the computing system can then query one or more data storages for one or more associations relevant to the data request. For example, if the data request comprises a main account identifier, the computing system could query the one or more data storages for any associations comprising the main account identifier. In some instances, the computing system can query and obtain data from all additional accounts, including accounts with pending invites (i.e., in the provisional association generated in block 523) and accounts that have already accepted the invite (i.e., in the non-provisional association generated in block 528). This could involve the computing system querying and obtaining data from more than one data structure, storages and/or services. The computing system could send separate sets of data corresponding to responses from different databases (e.g., data about pending accounts and data about accepted accounts in separate data sets) or combine the data in a single data set to be sent in one or more messages.

The data can be transmitted to the main account for display and/or management of the additional accounts, as indicated in blocks 624, 612, 613 and 614 in the same or similar ways to respective blocks 526, 512, 513 and 514 described with reference to FIG. 5A. In some instances, data sent in block 526 of FIG. 5A and/or block 529 in FIG. 5B is sent based on a request such as the request described with reference to FIG. 6.

Example user interface 700 in FIG. 7 illustrates example graphical representations 710 and 720 corresponding to additional accounts associated with the system. Graphical representations 710 can correspond to additional accounts that have already completed an invite/onboarding process such as the processes described in FIG. 5B. Data for generating these representations can be obtained from the non-provisional associations generated in block 528 of method 520B in FIG. 5B. As illustrated, the representations can include any information identifying the additional account, such as a username or other identifier, an account identifier, an e-mail address or other contact information, etc. Additionally, the representations can include an indication of the role of the additional account in the system. Additionally, the representations can include an indication of the resources that the additional account has access to in the system. As illustrated, the user interface could provide options to manage (e.g., edit, remove, etc.) the additional accounts. Using these selectable options, the main account could manage any data for the additional accounts, such as change the role and/or grants.

Graphical representations 720 can correspond to additional accounts that have not yet completed an invite/onboarding process such as the process described in FIG. 5B. Data for generating these representations can be obtained from the provisional associations generated in block 523 of method 520 in FIG. 5A. The graphical representations 720 could include the same data as graphical representations 710. Additionally, the representations 720 could include a status indication that indicates that the invite is pending. The representation could also include an expiration date. As illustrated, the user interface could provide options to manage (e.g., edit, remove, etc.) the invited accounts. Using these selectable medications, the main account could manage any data for the invited accounts, such as change the role and/or grants. Other example user interfaces are described in U.S. Prov. Pat Application No. 63/459,909, filed Apr. 17, 2023, entitled “Dashboard User Interface” and U.S. patent application Ser. No. 18/430,160, filed Feb. 1, 2024, entitled “Dashboard User Interface”, the contents of each of which are incorporated by reference in their entirety.

In some instances, invites have a predetermined expiration time (e.g., one week, 14 days, one month, etc.). The expiration time can be set and/or modified by the main account. In some instances, the invite can be removed (e.g., automatically removed) after the expiration time. Removing the invite can include deleting any data associated with the invite such as user personal data for privacy reasons. Removing the invite can include removing a graphical representation such as representation 720 corresponding to the invited account from the user interface 700. Removing the invite can include deactivating/revoking the invite so that the invited user is no longer able to join the system using the invite. In some instances, invites can be re-sent (e.g., during the lifetime of the invite or after it has expired). In some instances, the re-send option is made available (e.g., displayed) a period of time after the invite has been sent (e.g., after or near the expiration time of the invite). In some instances, re-sending the invite can reset the expiration time and/or restart the expiration countdown. An invited user can be associated with the system after accepting the invite, as explained before. Generating, sending and/or receiving an invite does not necessarily create an account for the invited user. The account may be created before the invite is transmitted (e.g., users who are already existing users of the media playback system provider) or after the invite is transmitted (e.g., as a result of redeeming the invite).

Roles assigned during invite process can also be modified over time. For example, if an employee changes to a different function or location, their role can be updated accordingly to have access to more/less resources and/or functionalities in the system. Furthermore, roles (or access altogether) can be revoked (for example if an employee leaves the company). These modifications can be performed via a user interface such as user interface 700 (e.g., via the “edit”, “remove” and/or “manage invite” options illustrated in the example user interface). In some instances, access can be granted temporarily. The timing information can be configured during the invite process so that the invite grants access to the system in accordance with any time limitation established for the particular user. In this way, temporary users like customers in a hotel, installers, DJs, etc. can have access to the system subject to the resources, role, and time assigned to them. In some instances, certain role buckets can be provided to facilitate adding users to the system. In this way, when designing a new feature and/or determining access, a main account could only consider the experience for a known, finite list of roles. For example, when adding/inviting a new user the system can recommend a set of predetermined roles that would work best for their control needs (e.g., “restrictive restaurant” or “loose lounge” that map to roles typical for those establishments).

Although the examples described above in this disclosure generally involve a main account and additional accounts, any of the additional accounts can act as a main account for the resources they own and/or resources they have been granted access to, if their role allows. Additional accounts could invite other additional accounts to access any resource in the system that they have access to. In this way, a regional manager of a region comprising a group of locations could be able to add employees to the locations in the region, but not to locations in other regions.

The explicit and implicit grants described above in this disclosure can be used to determine whether an account is authorized to access a resource. In some instances, however, the role of the account determines what the additional account can do with the resource. For example, for a first account with a given role (e.g., employee) and explicit access to a playback device, the employee may only be able to see the playback device in a user interface of a controller application, see the playback status, and start playback within business hours. For a second account with another role, (e.g., admin) and explicit access to the same playback device, the admin may be able to stop/start playback at any time, add content for playback, change system configuration, etc. Therefore, grants can determine what resources can be accessed, but roles may determine how those resources can be accessed (e.g., what functionalities can be accessed).

Some examples in this disclosure refer to an account (e.g., main account, additional accounts) taking certain actions. These actions can be taken (or caused to be taken) by a user of the account and/or in response to actions/inputs received from a user of the account. The actions can be taken by any device via which the accounts are accessed. Similarly, certain examples in this disclosure refer to an account (e.g., main account, additional accounts) allowed/not allowed to take certain actions, which can include the user and/or any device with access to the main account allowed/not allowed to take the actions.

Some examples in this disclosure refer to an account attempting or trying to access a resource. Some examples refer to an account sending an access request to access the resource. Accessing a resource, as used herein, could include obtaining information about the resource. Accessing a resource, as used herein, could include communicating with the resource. Accessing a resource, as used herein, could include managing and/or controlling any aspect of the resource. For example, accessing the resource could include sending a command to cause the resource to take an action and or control a functionality.

In some embodiments, for example, a computing device is provided. The computing device comprises at least one processor, and at least one non-transitory computer-readable medium comprising program instructions that are executable by the at least one processor such that the computing device is configured to: receive, from a main account associated with a media playback system, an invite request to invite an additional account to access a set of one or more resources of the media playback system; based on the invite request, generate, via a first service a first association, wherein the first association comprises an association between the additional account and one or more of: (i) the main account, or (ii) the set of one or more resources; after generating the first association, receive, from a user device associated with the additional account, an access request to access at least one functionality for a particular resource in the media playback system; based on a determination that the first association does not comprise an association between the additional account and the particular resource, query a second service to obtain data corresponding to a second association, wherein the second association comprises an association between one or more of: (i) the main account and the particular resource, or (ii) the set of one or more resources and the particular resource; and based on both the first association and the second association, allow the additional account to access the at least one functionality for the particular resource.

In some embodiments, for example, a non-transitory computer-readable medium is provided. The non-transitory computer-readable medium having stored thereon instructions executable by one or more processors to cause a computing system to perform functions comprising: receiving, from a main account associated with a media playback system, an invite request to invite an additional account to access a set of one or more resources of the media playback system; based on the invite request, generating, via a first service a first association, wherein the first association comprises an association between the additional account and one or more of: (i) the main account, or (ii) the set of one or more resources; after generating the first association, receiving, from a user device associated with the additional account, an access request to access at least one functionality for a particular resource in the media playback system; based on a determination that the first association does not comprise an association between the additional account and the particular resource, querying a second service to obtain data corresponding to a second association, wherein the second association comprises an association between one or more of: (i) the main account and the particular resource, or (ii) the set of one or more resources and the particular resource; and based on both the first association and the second association, allowing the additional account to access the at least one functionality for the particular resource.

In some embodiments, for example, a method is provided. The method comprising: receiving, from a main account associated with a media playback system, an invite request to invite an additional account to access a set of one or more resources of the media playback system; based on the invite request, generating, via a first service a first association, wherein the first association comprises an association between the additional account and one or more of: (i) the main account, or (ii) the set of one or more resources; after generating the first association, receiving, from a user device associated with the additional account, an access request to access at least one functionality for a particular resource in the media playback system; based on a determination that the first association does not comprise an association between the additional account and the particular resource, querying a second service to obtain data corresponding to a second association, wherein the second association comprises an association between one or more of: (i) the main account and the particular resource, or (ii) the set of one or more resources and the particular resource; and based on both the first association and the second association, allowing the additional account to access the at least one functionality for the particular resource.

In some embodiments, the one or more resources comprise one or more of: (i) one or more playback devices of the media playback system; (ii) one or more partitions of the media playback system; or (iii) one or more locations of the media playback system. In some embodiments, after generating the first association, an access request to access at least one functionality for the set of one or more resources is received from the user device registered with the additional account; and based on a determination that the first association comprises an association between the additional account and the set of one or more resources, the additional account is allowed to access to the at least one functionality for the set of one or more resources.

In some embodiments, receiving the invite request comprises receiving one or more messages corresponding to the invite request; and the one or more messages collectively comprise an identifier corresponding to the additional account and an identifier corresponding to the set of one or more resources. In some embodiments, the one or more messages further collectively comprise an indication of a role for the additional account in the media playback system; and allowing the additional account to access the at least one functionality for the particular resource comprises allowing the additional account to access the at least one functionality for the particular resource based on the role.

In some embodiments, the computing system is configured to communicate with one or more of the first service and the second service via at least one application programming interface (API). In some embodiments, the computing system is configured to: receive, from the user device registered with the additional account, a second access request to access the at least one functionality for the particular resource in the media playback system; and based on a determination that a topology of the media playback system has changed, deny the additional account access to the at least one functionality for the particular playback device. In some embodiments, determining that the topology of the media playback system has changed comprises determining that the second association no longer comprises an association between the group of one or more resources and the particular resource. In some embodiments, determining that the topology of the media playback system has changed comprises receiving a topology update indication corresponding to a change in the topology of the media playback system. In some embodiments, receiving the topology update indication corresponding to a change in the topology of the media playback system comprises receiving an indication that the particular resource has been disconnected from the group of one or more resources.

In some embodiments, the set of resources comprises one or more playback devices distributed across one or more partitions of the media playback system; and each partition in the group of one or more partitions comprises at least one playback device connected to a local area network (LAN) different from a LAN to which other playback devices in other partitions are connected. In some embodiments, the data corresponding to the second association comprises topology data corresponding to a topology of the media playback system, wherein the topology data comprises the association between the set of resources and the particular resource.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A computing system comprising:
at least one processor; and
at least one non-transitory computer-readable medium comprising program instructions that are executable by the at least one processor such that the computing system is configured to:
receive, from a main account associated with a media playback system, an invite request to invite an additional account to access a set of one or more resources of the media playback system;
based on the invite request, generate, via a first service, a first association, wherein the first association comprises an association between the additional account and one or more of: (i) the main account, or (ii) the set of one or more resources;
after generating the first association, receive, from a user device associated with the additional account, an access request to access at least one functionality for a particular resource in the media playback system;
based on a determination that the first association does not comprise an association between the additional account and the particular resource, query a second service to obtain data corresponding to a second association, wherein the second association comprises an association between one or more of: (i) the main account and the particular resource, or (ii) the set of one or more resources and the particular resource; and
based on both the first association and the second association, allow the additional account to access the at least one functionality for the particular resource.

2. The computing system of claim 1, wherein the set of one or more resources comprises one or more of: (i) one or more playback devices of the media playback system; (ii) one or more partitions of the media playback system; or (iii) one or more locations of the media playback system.

3. The computing system of claim 1, wherein the at least one non-transitory computer-readable medium further comprises program instructions such that the computing system is configured to:
after generating the first association, receive, from the user device registered with the additional account, an access request to access at least one functionality for the set of one or more resources; and
based on a determination that the first association comprises an association between the additional account and the set of one or more resources, allow the additional account to access to the at least one functionality for the set of one or more resources.

4. The computing system of claim 1, wherein:
receiving the invite request comprises receiving one or more messages corresponding to the invite request; and
the one or more messages collectively comprise an identifier corresponding to the additional account and an identifier corresponding to the set of one or more resources.

5. The computing system of claim 4, wherein:
the one or more messages further collectively comprise an indication of a role for the additional account in the media playback system; and
allowing the additional account to access the at least one functionality for the particular resource comprises allowing the additional account to access the at least one functionality for the particular resource based on the role.

6. The computing system of claim 1, wherein:
the computing system is configured to communicate with one or more of the first service and the second service via at least one application programming interface (API).

7. The computing system of claim 1, wherein the at least one non-transitory computer-readable medium further comprises program instructions such that the computing system is configured to:
receive, from the user device registered with the additional account, a second access request to access the at least one functionality for the particular resource in the media playback system; and
based on a determination that a topology of the media playback system has changed, deny the additional account access to the at least one functionality for the particular resource.

8. The computing system of claim 7, wherein determining that the topology of the media playback system has changed comprises determining that the second association no longer comprises an association between the set of one or more resources and the particular resource.

9. The computing system of claim 7, wherein determining that the topology of the media playback system has changed comprises receiving a topology update indication corresponding to a change in the topology of the media playback system.

10. The computing system of claim 9, wherein receiving the topology update indication corresponding to a change in the topology of the media playback system comprises receiving an indication that the particular resource has been disconnected from the set of one or more resources.

11. The computing system of claim 1, wherein:
the set of one or more resources comprises one or more playback devices distributed across a group of one or more partitions of the media playback system; and
each partition in the group of one or more partitions comprises at least one playback device connected to a local area network (LAN) different from a LAN to which other playback devices in other partitions are connected.

12. The computing system of claim 1, wherein the data corresponding to the second association comprises topology data corresponding to a topology of the media playback system, and wherein the topology data comprises the association between the set of one or more resources and the particular resource.

13. A non-transitory computer-readable medium having stored thereon instructions executable by one or more processors to cause a computing system to perform functions comprising:
receiving, from a main account associated with a media playback system, an invite request to invite an additional account to access a set of one or more resources of the media playback system;
based on the invite request, generating, via a first service, a first association, wherein the first association comprises an association between the additional account and one or more of: (i) the main account, or (ii) the set of one or more resources;
after generating the first association, receiving, from a user device associated with the additional account, an access request to access at least one functionality for a particular resource in the media playback system;
based on a determination that the first association does not comprise an association between the additional account and the particular resource, querying a second service to obtain data corresponding to a second association, wherein the second association comprises an association between one or more of: (i) the main account and the particular resource, or (ii) the set of one or more resources and the particular resource; and
based on both the first association and the second association, allowing the additional account to access the at least one functionality for the particular resource.

14. The non-transitory computer-readable medium of claim 13, wherein the set of one or more resources comprise one or more of: (i) one or more playback devices of the media playback system; (ii) one or more partitions of the media playback system; or (iii) one or more locations of the media playback system.

15. The non-transitory computer-readable medium of claim 13, further comprising program instructions such that the computing system is configured to:
after generating the first association, receive, from the user device registered with the additional account, an access request to access at least one functionality for the set of one or more resources; and
based on a determination that the first association comprises an association between the additional account and the set of one or more resources, allow the additional account to access to the at least one functionality for the set of one or more resources.

16. The non-transitory computer-readable medium of claim 13, wherein:
receiving the invite request comprises receiving one or more messages corresponding to the invite request; and
the one or more messages collectively comprise an identifier corresponding to the additional account and an identifier corresponding to the set of one or more resources.

17. The non-transitory computer-readable medium of claim 16, wherein:
the one or more messages further collectively comprise an indication of a role for the additional account in the media playback system; and
allowing the additional account to access the at least one functionality for the particular resource comprises allowing the additional account to access the at least one functionality for the particular resource based on the role.

18. The non-transitory computer-readable medium of claim 13, wherein:
the computing system is configured to communicate with one or more of the first service and the second service via at least one application programming interface (API).

19. The non-transitory computer-readable medium of claim 13, further comprising program instructions such that the computing system is configured to:
receive, from the user device registered with the additional account, a second access request to access the at least one functionality for the particular resource in the media playback system; and
based on a determination that a topology of the media playback system has changed, deny the additional account access to the at least one functionality for the particular resource.

20. A method to be performed by a computing device, the method comprising:
receiving, from a main account associated with a media playback system, an invite request to invite an additional account to access a set of one or more resources of the media playback system;
based on the invite request, generating, via a first service, a first association, wherein the first association comprises an association between the additional account and one or more of: (i) the main account, or (ii) the set of one or more resources;
after generating the first association, receiving, from a user device associated with the additional account, an access request to access at least one functionality for a particular resource in the media playback system;
based on a determination that the first association does not comprise an association between the additional account and the particular resource, querying a second service to obtain data corresponding to a second association, wherein the second association comprises an association between one or more of: (i) the main account and the particular resource, or (ii) the set of one or more resources and the particular resource; and
based on both the first association and the second association, allowing the additional account to access the at least one functionality for the particular resource.
